(19) United States
(12) Patent Application Publication
(10) Pub. No.: US 2021/0061002 A1
(43) Pub. Date: Mar. 4, 2021

(54) TIRE RIM PROTECTION DEVICE

(71) Applicant: John Vela, Hockley, TX (US)

(72) Inventor: John Vela, Hockley, TX (US)

(21) Appl. No.: 16/552,916

(22) Filed: Aug. 27, 2019

(51) Int. Cl. B60B 7/14; B60B 7/08; B60B 7/06; B60B 7/16

(52) U.S. Cl. CPC B60B 7/14; B60B 7/16; B60B 7/063; B60B 7/08

(57) ABSTRACT

A tire rim protection device, including a rim cover to cover at least a portion of a tire rim, at least one key bolt to connect the rim cover to the tire rim, and a round key to connect to the at least one key bolt, such that the at least one key bolt fastens the rim cover to the tire rim in response to a rotation of the round key.

### BACKGROUND

### 1. Field

The present general inventive concept relates generally to a protection device, and particularly, to a tire rim protection device.

### 2. Description of the Related Art

Traditional tire rim covers do not offer much in terms of security features. Although, traditional rim covers may protect tire rims from weather and temperature exposure, they do not protect tire rims from theft.

Additionally, tire rims are notoriously easy to maneuver away from a vehicle once a potential thief gains access to and removes lug nuts from a tire.

Therefore, there is a need for a tire rim protection device that prevents the potential thief from gaining access to the tire rim.

### SUMMARY

The present general inventive concept provides a tire rim protection device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a tire rim protection device, including a rim cover to cover at least a portion of a tire rim, at least one key bolt to connect the rim cover to the tire rim, and a round key to connect to the at least one key bolt, such that the at least one key bolt fastens the rim cover to the tire rim in response to a rotation of the round key.

The round key may include a dome surface to facilitate gripping thereof, a cylindrical surface disposed at an end of the dome surface, and a plurality of protruding members disposed at another end of the cylindrical surface to increase friction to the at least one key bolt.

The tire rim protection device may further include an adjustable sleeve removably connected to a rear portion of the tire rim to connect to the rim cover.

The tire rim protection device may further include a connecting wedge removably connected to the adjustable sleeve to receive the at least one key bolt within at least a portion thereof.

The at least one key bolt may include a key-receiving portion to receive the round key therein, and a cylindrical portion disposed at an end of the key-receiving portion to connect to the connecting wedge, such that the at least one key bolt prevents the rim cover from being removed.

The tire rim protection device may further include a key bolt supporting spring removably disposed within at least an interior portion of the adjustable sleeve to extract the at least one key bolt from within the rim cover.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates an exploded side sectional view of a tire rim protection device, according to an exemplary embodiment of the present general inventive concept;

FIG. 1B illustrates a side sectional view of the tire rim protection device, according to an exemplary embodiment of the present general inventive concept;

FIG. 2 illustrates a top isometric view of a round key and at least one key bolt, according to an exemplary embodiment of the present general inventive concept;

FIG. 3 illustrates a side sectional view of the tire rim protection device with at least one lug nut, according to an exemplary embodiment of the present general inventive concept; and

FIG. 4 illustrates a zoomed in side sectional view of a rim cover disposed on a tire rim, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Tire Rim Protection Device 100
Rim Cover 110
Body 111
Key-Receiving Aperture 112
Key Tube 113
Key Bolt 120
Key-Receiving Portion 121
Cylindrical Portion 122
Round Key 130
Dome Surface 131
Cylindrical Surface 132
Protruding Members 133
Adjustable Sleeve 140
Hooks 141
Rails 142
Ridged Members 143
Key Bolt Supporting Spring 150
Connecting Wedge 160
Plug 170

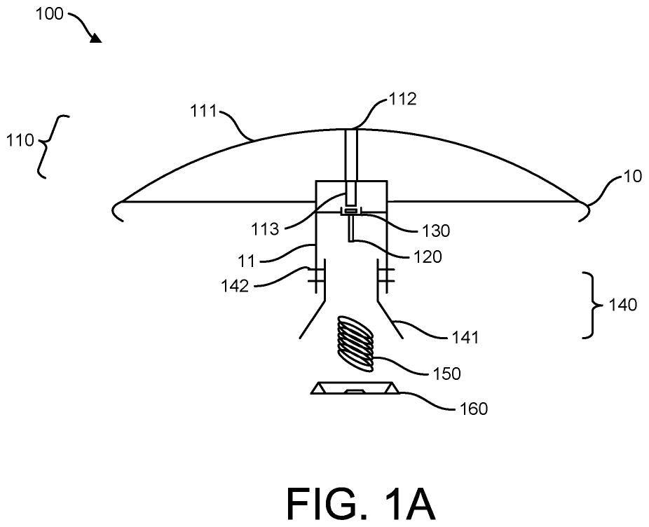

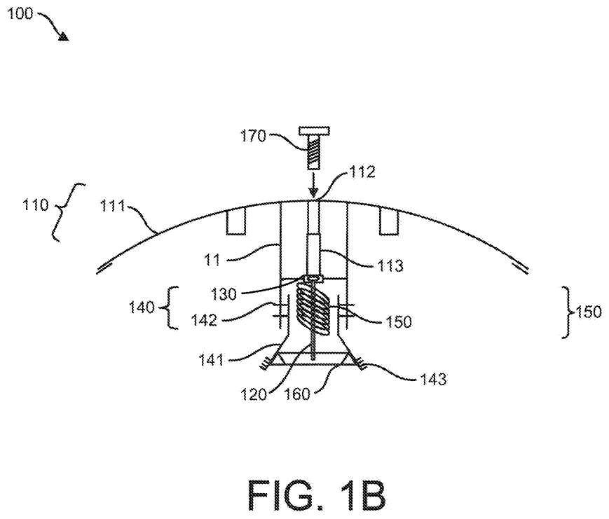

FIG. 1A illustrates an exploded side sectional view of a tire rim protection device 100, according to an exemplary embodiment of the present general inventive concept.

FIG. 1B illustrates a side sectional view of the tire rim protection device 100, according to an exemplary embodiment of the present general inventive concept.

The tire rim protection device 100 may be constructed from at least one of metal, plastic, wood, and rubber, etc., but is not limited thereto.

The tire rim protection device 100 may include a rim cover 110, at least one key bolt 120, a round key 130, an adjustable sleeve 140, a key bolt supporting spring 150, a connecting wedge 160, and a plug 170, but is not limited thereto.

The rim cover 110 may include a body 111, a key-receiving aperture 112, and a key tube 113, but is not limited thereto.

Referring to FIGS. 1A and 1B, the body 111 is illustrated to be a circular dome shape. However, the body 111 may be rectangular, conical, pentagonal, hexagonal, octagonal, or any other shape known to one of ordinary skill in the art, but is not limited thereto.

Additionally, the body 111 may be of any predetermined size to fit on a tire rim 10. The body 111 may be highly durable, weatherproof, waterproof, and scratch-resistant.

The key-receiving aperture 112 may be disposed at a center of the body 111 on a top portion thereof. Furthermore, the key-receiving aperture 112 may be connected to the key tube 113. In other words, the key tube 113 may be disposed within at least a portion of an interior of the body 111 at the center thereof.

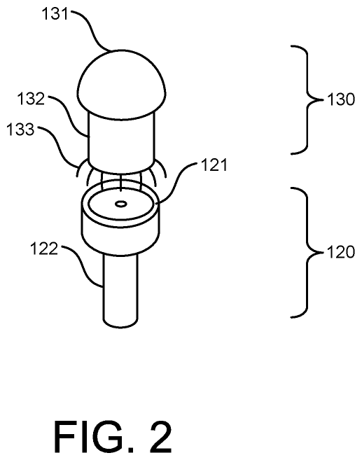

FIG. 2 illustrates a top isometric view of a round key 130 and at least one key bolt 120, according to an exemplary embodiment of the present general inventive concept.

The at least one key bolt 120 may include a key-receiving portion 121 and a cylindrical portion 122, but is not limited thereto.

The key-receiving portion 121 may have a diameter larger than a diameter of the cylindrical portion 122. Moreover, the key-receiving portion 121 may include a groove disposed around at least a portion of an edge of a top surface of the key-receiving portion 121. The cylindrical portion 122 may be disposed at an end of the key-receiving portion 121.

The at least one key bolt 120 may be inserted into the key-receiving aperture 112, such that the at least one key bolt 120 may be contained within at least a portion of the key tube 113.

The round key 130 may include a dome surface 131, a cylindrical surface 132, and a plurality of protruding members 133, but is not limited thereto.

The dome surface 131 may be a smooth surface and/or a textured surface to facilitate gripping thereof, such as a knurled surface and/or a plurality of bubbled protrusions extending away therefrom. The cylindrical surface 132 may be disposed on at least a portion of the dome surface 131. More specifically, the dome surface 131 may be disposed at a first end of the cylindrical surface 132. Moreover, a diameter of the dome surface 131 may be greater than a diameter of the cylindrical surface 132.

The plurality of protruding members 133 may be disposed at a second end of the cylindrical surface 132, such that the plurality of protruding members 133 may be circumferentially disposed on the cylindrical surface 132.

The round key 130 may be inserted into the key-receiving aperture 112, such that the plurality of protruding members 133 may contact the groove on the key-receiving portion 121. In other words, the groove of the key-receiving portion 121 may receive the plurality of protruding members 133 therein. Furthermore, the plurality of protruding members 133 may increase friction within the groove of the key-receiving portion 121, such that the at least one key bolt 120 may rotate in response to a rotation of the round key 130. As such, the round key 130 may fasten the rim cover 110 to the tire rim 10 via the at least one key bolt 120.

The adjustable sleeve 140 may include a plurality of hooks 141, a plurality of rails 142, and a plurality of ridged members 143, but is not limited thereto.

The adjustable sleeve 140 may be removably connected to a rear portion of the tire rim 10. The plurality of hooks 141 may be oriented at an angle with respect to a center column 11 of the tire rim 10.

The plurality of rails 142 may be disposed on at least a portion of the plurality of hooks 141, such that the adjustable sleeve 140 may move at least partially within the center column 11 of the tire rim 10. Specifically, the plurality of rails 142 may facilitate movement of the adjustable sleeve 140 in a first lateral direction or a second lateral direction toward the cover rim 10, and movement away from the cover rim 10 in the second lateral direction or the first lateral direction.

Furthermore, the plurality of ridged members 143 may be disposed on at least a portion of the plurality of hooks 141 to prevent the plurality of hooks 141 from moving toward the rim cover 110. In other words, the plurality of ridged members 143 may prevent removal of the rim cover 110, such that a thief may access contents under the rim cover 110.

The key bolt supporting spring 150 may be removably disposed within at least an interior portion of the adjustable sleeve 140. The key bolt supporting spring 150 may receive the at least one key bolt 120 thereupon to extract the at least one key bolt 120 in response to loosening the at least key bolt 120.

The connecting wedge 160 may be removably disposed between the plurality of hooks 141. The connecting wedge 160 may receive the at least one key bolt 120 within at least a portion thereof, such that the at least one key bolt 120 may fasten the rim cover 110 to the tire rim 10. Specifically, the at least one key bolt 120 may fasten the rim cover 110 to the tire rim 10 in response to rotation of the round key 130 in a first direction (i.e. clockwise) or a second direction (counterclockwise), such that the cylindrical portion 122 of the at least one key bolt 120 may move within at least a portion of the connecting wedge 160. Alternatively, the at least one key bolt 120 may release (i.e. loosen) the rim cover 110 from the tire rim 10 in response to rotation of the round key 130 in the second direction or the first direction, such that the cylindrical portion 122 of the at least one key bolt 120 may move away from the connecting wedge 160, such that the key bolt supporting spring 150 may extract the at least one key bolt 120 therefrom. In other words, loosening the at least one key bolt 120 may allow the rim cover 110 to be removed.

The plug 170 may be removably disposed within the key-receiving aperture 112. The plug 170 may include an adhesive on at least a portion thereof to prevent access to the at least one key bolt 120.

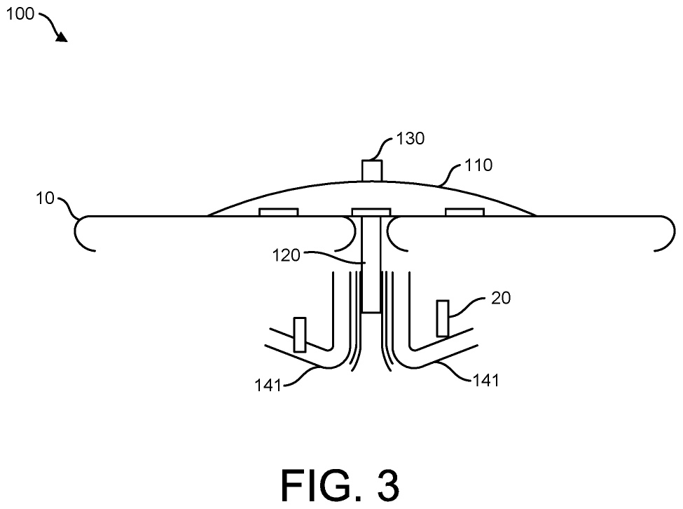

FIG. 3 illustrates a side sectional view of the tire rim protection device 100 with at least one lug nut 20, according to an exemplary embodiment of the present general inventive concept.

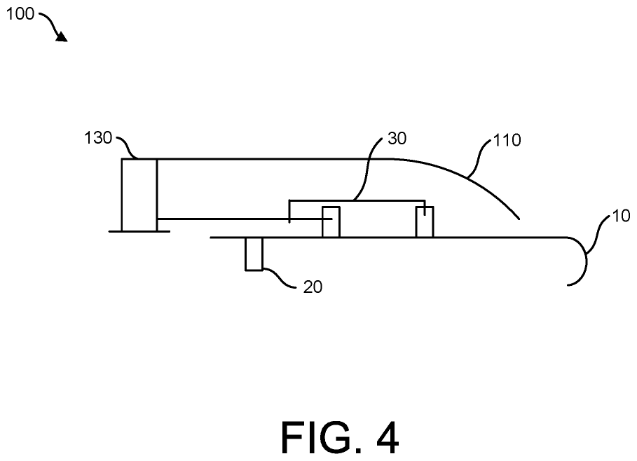

FIG. 4 illustrates a zoomed in side sectional view of a rim cover 110 disposed on a tire rim 10, according to an exemplary embodiment of the present general inventive concept.

Therefore, the rim cover 110 may prevent access to the tire rim 10. Specifically, the rim cover 110 may cover at least a portion of the tire rim 10, as well as, at least one lug nut 20 and at least one hinge pin 30. As such, the tire rim protection device 100 may prevent access to the at least one lug nut 20 and the at least one hinge pin 30, such that theft of the tire rim 10 may not occur.

The present general inventive concept may include a tire rim protection device 100, including a rim cover 110 to cover at least a portion of a tire rim 10, at least one key bolt 120 to connect the rim cover 110 to the tire rim 10, and a round key 130 to connect to the at least one key bolt 120, such that the at least one key bolt 120 fastens the rim cover 110 to the tire rim 10 in response to a rotation of the round key 130.

The round key 130 may include a dome surface 131 to facilitate gripping thereof, a cylindrical surface 132 disposed at an end of the dome surface 131, and a plurality of protruding members 133 disposed at another end of the cylindrical surface 132 to increase friction to the at least one key bolt 120.

The tire rim protection device 100 may further include an adjustable sleeve 140 removably connected to a rear portion of the tire rim 10 to connect to the rim cover 110.

The tire rim protection device 100 may further include a connecting wedge 160 removably connected to the adjustable sleeve 140 to receive the at least one key bolt 120 within at least a portion thereof.

The at least one key bolt 120 may include a key-receiving portion 121 to receive the round key 130 therein, and a cylindrical portion 122 disposed at an end of the key-receiving portion 121 to connect to the connecting wedge 160, such that the at least one key bolt 120 prevents the rim cover 110 from being removed.

The tire rim protection device 100 may further include a key bolt supporting spring 150 removably disposed within at least an interior portion of the adjustable sleeve 140 to extract the at least one key bolt 120 from within the rim cover 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A tire rim protection device, comprising:
a rim cover to cover at least a portion of a tire rim;
at least one key bolt to connect the rim cover to the tire rim; and
a round key to connect to the at least one key bolt, such that the at least one key bolt fastens the rim cover to the tire rim in response to a rotation of the round key.

2. The tire rim protection device of claim 1, wherein the round key comprises:
a dome surface to facilitate gripping thereof;
a cylindrical surface disposed at an end of the dome surface; and
a plurality of protruding members disposed at another end of the cylindrical surface to increase friction to the at least one key bolt.

3. The tire rim protection device of claim 1, further comprising:
an adjustable sleeve removably connected to a rear portion of the tire rim to connect to the rim cover.

4. The tire rim protection device of claim 3, further comprising:
a connecting wedge removably connected to the adjustable sleeve to receive the at least one key bolt within at least a portion thereof.

5. The tire rim protection device of claim 4, wherein the at least one key bolt comprises:
a key-receiving portion to receive the round key therein; and
a cylindrical portion disposed at an end of the key-receiving portion to connect to the connecting wedge, such that the at least one key bolt prevents the rim cover from being removed.

6. The tire rim protection device of claim 3, further comprising:
a key bolt supporting spring removably disposed within at least an interior portion of the adjustable sleeve to extract the at least one key bolt from within the rim cover.
